(19) United States
(12) Patent Application Publication
(10) Pub. No.: US 2021/0158269 A1
(43) Pub. Date: May 27, 2021

(54) INFORMATION PROCESSING APPARATUS, RECORDING MEDIUM AND INFORMATION PROCESSING METHOD

(71) Applicant: TOYOTA JIDOSHA KABUSHIKI KAISHA, Toyota-shi (JP)

(72) Inventor: Daiki KANEICHI, Tokyo-to (JP)

(73) Assignee: TOYOTA JIDOSHA KABUSHIKI KAISHA, Toyota-shi (JP)

(21) Appl. No.: 17/086,554

(22) Filed: Nov. 2, 2020

(30) Foreign Application Priority Data
Nov. 8, 2019 (JP) 2019-202924

(51) Int. Cl. G06Q 10/06; G08G 1/00; G06Q 10/10; G06Q 50/30; G06F 16/903

(52) U.S. Cl. CPC G06Q 10/063118; G08G 1/20; G06Q 10/06398; G06F 16/90335; G06Q 10/06315; G06Q 50/30; G06Q 10/109

(57) ABSTRACT

An information processing apparatus includes: a storage that stores driving history information including states of a taxi, driving positions and time stamps in association with a taxi driver; and a processor that analyzes the driving history information about the taxi driver corresponding to a predetermined period to acquire driver characteristics information pieces indicating behavioral characteristics of the taxi driver in a vacant state of the taxi. The processor acquires information indicating a first area within top N areas (N is a positive integer) where a time during which the taxi existed in the vacant state during the predetermined period is long as one of the driver characteristics information pieces; and creates, based on the driver characteristics information pieces about the plurality of taxi drivers, a work shift schedule for the taxi drivers so that the first area corresponding to each of the taxi drivers is dispersed.

### CROSS REFERENCE TO RELATED APPLICATION

This application claims the benefit of Japanese Patent Application No. 2019-202924, filed on Nov. 8, 2019, which is hereby incorporated by reference herein in its entirety.

### BACKGROUND

### Technical Field

The present disclosure relates to an information processing apparatus, a recording medium and an information processing method.

### Description of the Related Art

Taxi dispatch application systems capable of quickly realizing a taxi dispatch order or dispatch reservation by a simple operation of a customer communication terminal have been disclosed (for example, Patent document 1).

### CITATION LIST

### Patent Document

[Patent document 1] Japanese Patent Laid-Open No. 2014-029580

It is desirable to dispatch a taxi to a user as quickly as possible in response to a dispatch request from a customer communication terminal by a taxi dispatch application. For that purpose, it is effective to disperse taxis. However, taxi drivers drive the taxis of their own will; and, even if driving areas are designated, they do not necessarily drive in the designated areas.

A subject of one of disclosed aspects is to provide an information processing apparatus, a recording medium and an information processing method that are capable of acquiring behavioral characteristics of taxi drivers.

### SUMMARY

One aspect of the present disclosure is an information processing apparatus comprising:

a storage configured to store, in association with a taxi driver, driving history information including states of a taxi, driving positions and time stamps; and

a processor configured to analyze the driving history information about the taxi driver corresponding to a predetermined period to acquire driver characteristics information pieces indicating behavioral characteristics of the taxi driver in a vacant state of the taxi.

Another aspect of the present disclosure is a non-transitory computer-readable recording medium recorded with a program causing a computer:

store, in a storage, in association with a taxi driver, driving history information including states of a taxi, driving positions and time stamps; and

analyze the driving history information about the taxi driver corresponding to a predetermined period to acquire driver characteristics information pieces indicating behavioral characteristics of the taxi driver in a vacant state of the taxi.

Another aspect of the present disclosure is an information processing method comprising:

store, in a storage, in association with a taxi driver, driving history information including states of a taxi, driving positions and time stamps; and

analyzing the driving history information about the taxi driver corresponding to a predetermined period to acquire driver characteristics information pieces indicating behavioral characteristics of the taxi driver in a vacant state of the taxi.

According to the present disclosure, it is possible to acquire behavioral characteristics of taxi drivers.

### BRIEF DESCRIPTION OF DRAWINGS

FIG. 1 is a diagram illustrating an example of a system configuration of a taxi driving history collection system according to a first embodiment;

FIG. 2 is a diagram illustrating an example of a hardware configuration of the center server;

FIG. 3 is a diagram illustrating an example of functional configurations of the center server and each taxi in the taxi driving history collection system;

FIG. 4 is an example of a driving history information table;

FIG. 5 is an example of a driver characteristics information table;

FIG. 6 is an example of a flowchart of the driving history analysis process of the center server; and

FIG. 7 is an example of a flowchart of a work shift schedule creation process of the center server.

### DESCRIPTION OF THE EMBODIMENTS

For example, if it takes much time for a taxi to arrive at a designated place when a dispatch request from a user terminal by a taxi dispatch application occurs, a possibility of cancellation increases. This is an example of loss of an opportunity to get a taxi passenger. When the opportunity to get a taxi passenger is considered, it is better for taxis waiting for passengers to dispersedly exist without being concentrated at one place.

However, taxi drivers are human beings with wills. Therefore, even if a responsible area for each driver is assigned as a business instruction so that taxis are dispersed, some drivers do not follow the business instruction, and it is difficult to disperse drivers as planned. Therefore, in the present disclosure, behavioral characteristics of taxi drivers are acquired first. An example of a process using the behavioral characteristics of the taxi drivers is to create a work shift schedule based on the behavioral characteristics of the taxi drivers.

One of aspects of the present disclosure is an information processing apparatus including: a storage stores driving history information including states of a taxi, driving positions and time stamps in association with a taxi driver; and a processor that analyzes the driving history information about the taxi driver corresponding to a predetermined period to acquire driver characteristics information pieces indicating behavioral characteristics of the taxi driver when the taxi is in a vacant state.

As states of a taxi, there are, for example, a vacant state, an occupied state, an out-of-service state, a pick-up state and the like. The vacant state is a state in which a taxi is in business, but a passenger is not on board. The occupied state is a state in which a taxi is in business, and a passenger is on board the taxi. The occupied state is also referred to as a in service state. The out-of-service state is a state in which a taxi is not in business. The pick-up state is a state in which a taxi is in business and running to a designated place to pick up a passenger. Note that the states of a taxi are not limited thereto.

A driver's behavior when a taxi is in the vacant state depends on the driver's own will. Therefore, according to driving history information about the taxi in the vacant state, for example, the driver tends to more frequently drive in an area with which the driver is more familiar, or a total time of the vacant state tends to be shorter as the driver prefers a passenger whose movement distance is longer. In other words, according to the one of the aspects of the present disclosure, it is possible to acquire behavioral characteristics of the driver by analyzing a driving history of the taxi in the vacant state.

In one of the aspects of the present disclosure, the processor may acquire, as one of the driver characteristics information pieces, information indicating a first area within the top N areas (N is a positive integer) where a time during which the taxi existed in the vacant state during the predetermined period is long. The first area may be, for example, an area where a driver is familiar with roads, an area that the driver recognizes as an area where there are many opportunities to pick up a passenger from experience, and the like. A size, a shape and the like of an area that includes the first area can be arbitrarily set. Therefore, according to the one of the aspects of the present disclosure, it is possible to identify the area where a driver is familiar with roads and the area that the driver recognizes as an area where there are many opportunities to pick up a passenger from experience as the first area.

Further, according to one of the aspects of the present disclosure, the processor may execute acquiring the first area corresponding to the taxi driver for each of a plurality of time zones. The time zones at the time of acquiring the first area and the time zones of the work shift schedule may completely mutually correspond or may be in a relationship that one includes the other. A flow of people often differs according to time zones of commuting time, day, midnight and the like. Accordingly, an area where a taxi driver drives in the vacant state to get a passenger tends to differ according to time zones. In other words, even in the case of the same taxi driver, the first area may differ according to time zones. Therefore, by analyzing driving history information about a taxi for each time zone to acquire the first area corresponding to the taxi driver, characteristics of the driver for each time zone can be acquired.

In these cases, the processor may execute acquiring the driver characteristics information pieces about a plurality of taxi drivers; and creating, based on the driver characteristics information pieces about the plurality of taxi drivers, a work shift schedule for the taxi drivers so that the first area corresponding to each of the taxi drivers is dispersed.

Work shift scheduling is, for example, to determine drivers to work in predetermined time zones, and assignment of a responsible area to each driver is not included. By creating a work shift schedule so that the first areas are dispersed, the possibility of the drivers working in the predetermined time zones spontaneously drive in their first areas in the vacant state increases, and it is naturally possible to dispersedly arrange the taxis.

In one of the aspects of the present disclosure, the processor may execute acquiring vacant time information indicating a total time of the vacant state of the taxi during the predetermined period, as one of the driver characteristics information pieces. In this case, the processor may execute creating, based on the driver characteristics information pieces about the plurality of taxi drivers, the work shift schedule for the taxi drivers so that a predetermined number of such taxi drivers that a time during which the taxi runs in the vacant state is shorter or longer than a predetermined time are included in each of a plurality of areas in a business area that includes the plurality of areas.

That the total time of the vacant state of the taxi during the predetermined period is shorter or longer than the predetermined time represents that the driver tends to prefer a passenger who moves a long distance or a short distance, respectively. The predetermined number of such taxi drivers that the total time of the vacant state of the taxi is shorter or longer than the predetermined time, who are included in each area, may differ, for example, for each area or may be determined at a predetermined rate relative to the demanded number of taxis in each area. By creating a work shift schedule for taxi drivers so that the predetermined number of such taxi drivers that the total time of the vacant state of the taxi is shorter or longer than the predetermined time are included in each area, taxi drivers who prefer a long-distance movement or a short-distance movement can be arranged in each area. Thereby, it is possible to increase a possibility that taxi drivers' tastes and demands of passengers who move a long distance or a short distance can be matched.

Further, in one of the aspects of the present disclosure, the processor may execute acquiring the first area corresponding to the taxi driver by plotting the driving positions included in the driving history information on a map. Thereby, it is possible to acquire the first area corresponding to each driver.

In one of the aspects of the present disclosure, the processor may execute creating the work shift schedule for the taxi drivers so that, in a target area, the number of such taxi drivers that the target area is the first area is equal to or larger than a first number and equal to or smaller than a second number. The first number and the second number may be the same values. The first number and the second number may be uniform for all the areas, or different values may be set for each area. According to the one of the aspects of the present disclosure, a possibility that, in each area, the number of taxis of drivers for whom the area is the first area are arranged increases, the number being within a predetermined range.

Embodiments of the present disclosure will be described below based on drawings. Configurations of the embodiments below are examples, and the present disclosure is not limited to the configurations of the embodiments.

### First Embodiment

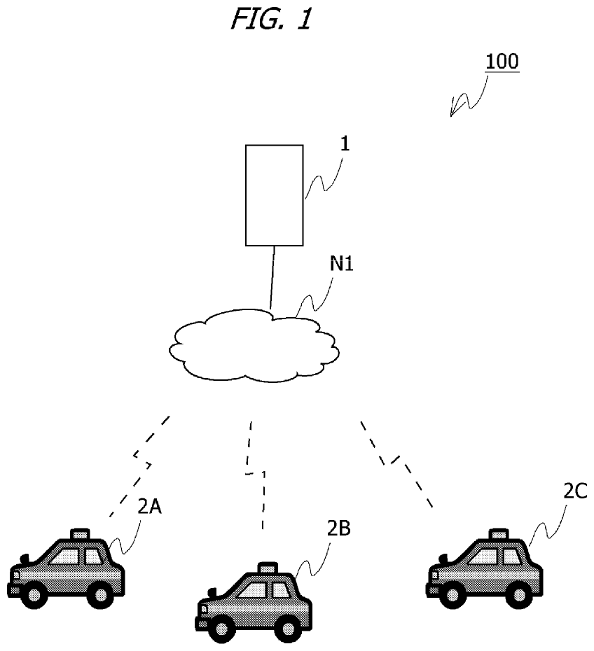

FIG. 1 is a diagram illustrating an example of a system configuration of a taxi driving history collection system 100 according to a first embodiment. The taxi driving history collection system 100 is, for example, a system that collects driving history information pieces about taxis and analyzes the collected driving history information pieces. A purpose of analysis of the driving history information pieces about taxis is, for example, to acquire characteristics of taxi drivers. However, the purpose of analysis of the driving histories of taxis is not limited thereto.

The taxi driving history collection system 100 includes, for example, a center server 1 and a plurality of taxis 2A, 2B and 2C. Taxis included in the taxi driving history collection system 100 are not limited to the three taxis 2A, 2B and 2C. The three are extracted among a plurality of taxis and illustrated. When the taxis included in the taxi driving history collection system 100 are not mutually distinguished, the taxis are expressed as taxis 2. Hereinafter, taxi drivers will be expressed merely as drivers.

Each taxi 2 includes, for example, a taximeter, an occupied/vacant indicator, a car navigation system, a taxi radio, a payment machine for credit and the like, a data communication apparatus, and the like. The occupied/vacant indicator is also called a super sign and indicates a state of the taxi. Indications of the occupied/vacant indicator include, for example, vacant, in service, pick-up, out-of-service and the like. The taxi 2 connects to a public network N1 such as the Internet by the mounted car navigation system, data communication apparatus or the like, for example, using any of mobile communication such as 5G, 4G and LTE (Long Term Evolution) and narrow band communication such as DSRC (Dedicated Short Range Communications).

The center server 1 is connected, for example, to the network N1 such as the Internet. The center server 1 and each taxi 2 are communicable via the network N1.

In the first embodiment, each taxi 2 transmits driving history information including identification information and position information about the taxi 2, a time stamp and content of indication of the occupied/vacant indicator to the center server 1, for example, at a predetermined period and each time a predetermined event occurs. The predetermined event that triggers transmission of the driving history information is, for example, the content of the indication of the occupied/vacant indicator being changed. However, the predetermined event that triggers transmission of the driving history information is not limited thereto.

The center server 1 stores the driving history information received from each taxi 2 and analyzes, for each driver, driving history information corresponding to a predetermined period to acquire characteristics of the driver. For example, from driving history information in the vacant state, an area where a time during which the driver exists in the vacant state is long can be acquired. The area where the time during which the driver exists in the vacant state is long indicates, for example, an area where the driver is familiar with roads or an area that the driver recognizes as an area where it is easy to get a passenger, from experience. Hereinafter, the area where the time during which the driver exists in the vacant state is long and where the driving history information in the vacant state is acquired, will be referred to as a strong area.

In the first embodiment, as a method of using an analysis result of driving history information pieces in the vacant state, the center server 1 generates a work shift schedule for drivers so that strong areas of the drivers are dispersed. Thereby, a possibility that each driver drives in his strong area of his own will when being in the vacant state increases, without designating a responsible area to the driver by a business instruction. Therefore, taxis can be naturally arranged being dispersed.

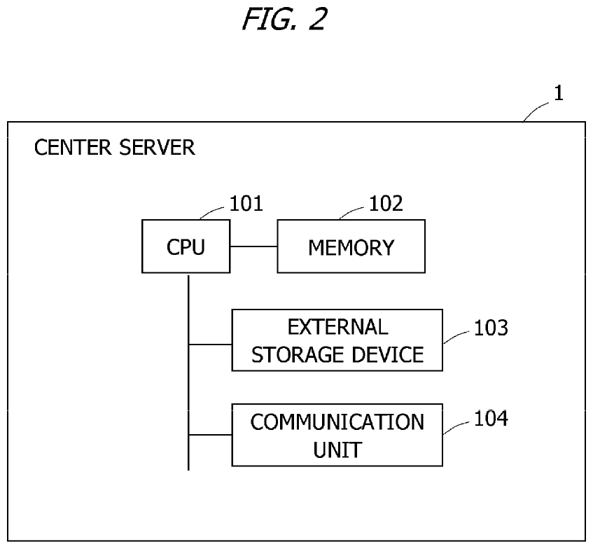

FIG. 2 is a diagram illustrating an example of a hardware configuration of the center server 1. The center server 1 is, for example, a dedicated computer or a general-purpose computer. The center server 1 has a CPU (Central Processing Unit) 101, a memory 102, an external storage device 103 and a communication unit 104 as hardware components. The memory 102 and the external storage device 103 are computer-readable recording media. The center server 1 is an example of “an information processing apparatus”.

The external storage device 103 stores various programs and data that the CPU 101 uses at the time of executing each program. The external storage device 103 is, for example, an EPROM (Erasable Programmable ROM) or a hard disk drive. The programs held in the external storage device 103 include, for example, an operating system (OS), a control program for the taxi driving history collection system 100 and other various application programs. The control program for the taxi driving history collection system 100 is a program for collecting and analyzing driving histories of the taxis 2.

The memory 102 is a main memory that provides a storage area to which a program stored in the external storage device 103 is loaded and a work area for the CPU 101 and is used as a buffer. The memory 102 includes a semiconductor memory, for example, like a ROM (Read Only Memory) and a RAM (Random Access Memory).

The CPU 101 executes various processes by loading the OS or the various application programs held in the external storage device 103 to the memory 102 and executing them. The number of CPUs 101 is not limited to one, but a plurality of CPUs 101 may be provided. The CPU 101 is an example of “a processor” of “the information processing apparatus”.

The communication unit 104 is an interface that performs input/output of information from/to a network. The communication unit 104 may be an interface that connects to a wired network or may be an interface that connects to a wireless network. The communication unit 104 is, for example, an NIC (Network Interface Card), a radio circuit or the like. The communication unit 104 connects, for example, to a LAN (Local Area Network), connects to a public network through the LAN and communicates with the taxis 2 via the public network.

An apparatus having a communication function, which is mounted on each taxi 2, has a CPU, a memory, an external storage device and a communication unit as hardware components. The apparatus having the communication function, which is mounted on each taxi 2, is, for example, a car navigation system, a data communication apparatus or the like. The apparatus having the communication function, which is mounted on each taxi 2, is further provided with a GPS receiver and acquires position information pieces about the taxi 2 at a predetermined period.

Note that a series of processes executed by the center server 1 and the apparatus having the communication function, which is mounted on each taxi 2, is not limited to being achieved by execution of software by a processor but can be achieved, for example, by hardware such as FPGA (Field-Programmable Gate Array).

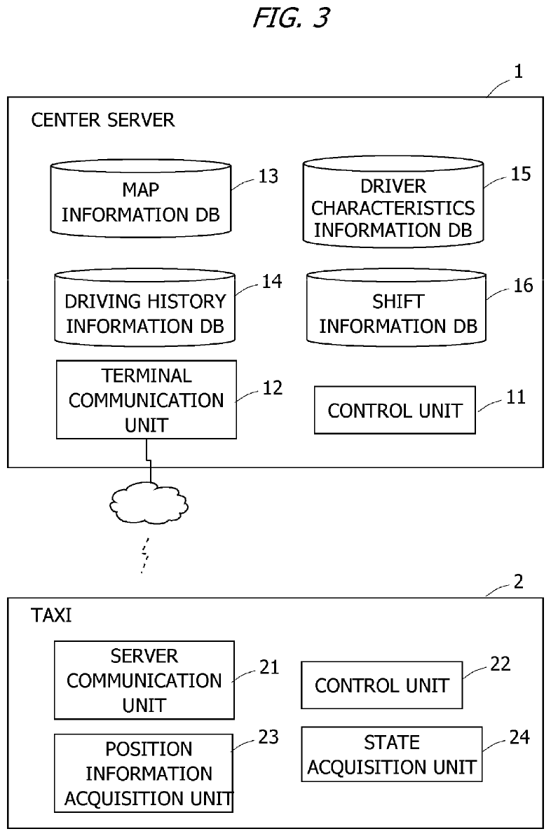

FIG. 3 is a diagram illustrating an example of functional configurations of the center server 1 and each taxi 2 in the taxi driving history collection system 100. First, the taxi 2 includes a server communication unit 21, a control unit 22, a position information acquisition unit 23 and a state acquisition unit 24 as functional components. Processes by these functional components are achieved, for example, by the CPU of the apparatus having the communication function, which is mounted on the taxi 2, executing a predetermined program stored in the external storage device.

The server communication unit 21 is an interface for communication with the center server 1. The server communication unit 21 receives, for example, input of driving history information from the control unit 22 and transmits the driving history information to the center server 1.

The position information acquisition unit 23 acquires, for example, position information about the taxi 2 acquired by the GPS receiving unit at a predetermined period and outputs the position information to a predetermined storage area of the memory. For example, the control unit 22 accesses the storage area of the memory to acquire the position information. The position information about the taxi 2 is, for example, a latitude and a longitude. The position information about the taxi 2 may be, for example, an address. The period of the position information acquisition unit 23 acquiring the position information may be set, for example, within a range of 0.1 to 10 seconds. However, the period is not limited thereto.

The state acquisition unit 24 acquires content of indication of the occupied/vacant indicator, for example, at a predetermined period and in response to occurrence of a predetermined event, and outputs the content to the predetermined storage area of the memory. The predetermined event that triggers the state acquisition unit 24 to acquire the content of the indication of the occupied/vacant indicator is, for example, change in the content of the indication of the occupied/vacant indicator. The change in the content of the indication of the occupied/vacant indicator occurs, for example, by an operation by the driver.

For example, the control unit 22 accesses the storage area of the memory to acquire the content of the indication of the occupied/vacant indicator of the taxi 2. The period of the state acquisition unit 24 acquiring the content of the indication of the occupied/vacant indicator may be set, for example, within a range of 10 seconds to 1 minute. However, the period is not limited thereto.

As the content of the indication of the occupied/vacant indicator, there are, for example, vacant, in service, pick-up, out-of-service and the like. “Vacant” indicates a state in which the taxi 2 is in business but a passenger is not on board. In other words, “vacant” is a state in which the taxi 2 is waiting for a passenger. “In service” indicates a state in which a passenger is on board the taxi 2. “Pick-up” indicates that the taxi 2 is in a state of running to a place designated by a passenger. “Out-of-business” indicates that a passenger is not on board the taxi and is out of business. Therefore, when “in service”, “pick-up” or “out-of-business” are displayed on the occupied/vacant indicator, the taxi 2 does not further cause a passenger to get on the taxi 2.

A state of the taxi 2 is determined by the center server 1 based on the content of the indication of the occupied/vacant indicator. States of the taxi 2 include, for example, the vacant state and states other than the vacant state. However, the states of the taxi 2 are not limited thereto and may be defined in more detail. It is, for example, when the content of the indication of the occupied/vacant indicator is “vacant” that the state of the taxi 2 is determined to be the vacant state. For example, if the content of the indication of the occupied/vacant indicator is “in service”, “pick-up” or “out-of-business”, the state of the taxi 2 is determined to be a state other than the vacant state.

The control unit 22 performs control about the driving history information about the taxi 2. The control unit 22 generates the driving history information, for example, at a predetermined period and in response to occurrence of a predetermined event. The predetermined event that triggers the driving history information to be generated is, for example, change in the content of the indication of the occupied/vacant indicator. The control unit 22 acquires position information about the taxi 2 and the content of the indication of the occupied/vacant indicator from the predetermined storage area of the memory and acquires, for example, a time stamp at the time point of the acquisition. The control unit 22 generates the driving history information including, for example, identification information about the taxi 2, the time stamp, the position information about the taxi 2 and the content of the indication of the occupied/vacant indicator. Note that information included in the driving history information about the taxi 2 is not limited thereto. The control unit 22 outputs the generated driving history information to the server communication unit 21 to transmit the driving history information to the center server 1 through the server communication unit 21.

Next, the center server 1 includes a control unit 11, a terminal communication unit 12, a map information database (DB) 13, a driving history information DB 14, a driver characteristics information DB 15 and a shift information DB 16 as functional components. These functional components are achieved, for example, by the CPU 101 of the center server 1 executing a control program for the center server 1 of the taxi driving history collection system 100 that is stored in the external storage device 103.

The terminal communication unit 12 controls communication with the apparatus of the taxi 2 having the communication function, which is performed through the communication unit 104. For example, when receiving the driving history information from the taxi 2, the terminal communication unit 12 outputs it to the control unit 11. When accepting input of the driving history information about the taxi 2 from the terminal communication unit 12, the control unit 11 stores the driving history information into the driving history information DB 14.

The control unit 11 performs a driving history analysis process for the taxi 2 according to a predetermined period or a command from an administrator. The period of the driving history analysis process for the taxi 2 is set, for example, to a unit of one day, one week, one month or one year. Further, the driving history analysis process for the taxi 2 is performed, for example, for driving history information about the taxi 2 corresponding to a predetermined period, in which the vacant state is indicated, as a target. The period targeted by the driving history analysis process for the taxi 2 may be set, for example, to a unit of one day, one week, one month or one year or may be from a time point of the last driving history analysis process to a current time point.

The control unit 11 acquires driver characteristics information by the driving history analysis process for the taxi 2. In the first embodiment, the strong area of the driver and a total time of the vacant state are acquired as the driver characteristics information. In the driving history analysis process for the taxi 2 in the first embodiment, for example, the control unit 11 plots positions of the taxi 2 indicated by the driving history information about the taxi 2 on a map. The map is stored in the map information DB 13 to be described later, and a plurality of areas with a predetermined size are set. A method for defining the areas is not limited to a predetermined method. For example, one area may be one of blocks obtained by being divided by meshes with a predetermined size or may be defined by a municipal division of an address.

For one driver, the control unit 11 calculates the number of plots for each of the areas and ranks the areas in descending order of the number of plots. For example, a high-ranking area is the strong area of the driver. However, definition of the strong area is not limited thereto. For example, such one area that a rate of the number of plots of the area to the total number of plots is higher than a predetermined value may be defined as the strong area. The control unit 11 stores the driver characteristics information acquired by the driving history analysis process for the taxi 2 into the driver characteristics information DB 15 to be described later.

Further, the control unit 11 performs creation of a work shift schedule as an example of a process using an analysis result of the driving history information. Creation of the work shift schedule is performed, for example, at a predetermined period or by an instruction from the administrator. In the first embodiment, the work shift schedule is created so that strong areas of working drivers are dispersed in each work time zone. Note that, in the first embodiment, the work shift schedule is such that designates drivers to work in each work time zone but does not designate a responsible area of each driver.

The map information DB 13, the driving history information DB 14, the driver characteristics information DB 15 and the shift information DB 16 are created, for example, in a storage area of the external storage device 103 of the center server 1. The map information DB 13 stores, for example, map information within a range targeted by the taxi driving history collection system 100. The driving history information DB 14 stores the driving history information received from each taxi 2. In the driver characteristics information DB 15, the driver characteristics information is stored. In the shift information DB 16, information about the work shift schedule is stored.

For example, for a taxi operator having the plurality of taxis 2 and the plurality of drivers, a relationship between the taxis 2 and the drivers is not fixed but floating. Therefore, in the shift information DB 16, driver boarding information indicating which driver is on board which taxi 2 is stored for each working date and time. Specifically, the driver boarding information includes association among the working dates and time, identification information pieces about the drivers and identification information pieces about the taxis 2. Further, in the shift information DB 16, information pieces about working days and work time zones the drivers desire is also stored.

Note that the functional components of the center server 1 may be achieved by one apparatus or may be achieved by a plurality of apparatuses. For example, the map information DB 13, the driving history information DB 14, the driver characteristics information DB 15 and the shift information DB 16 may be different database servers, respectively.

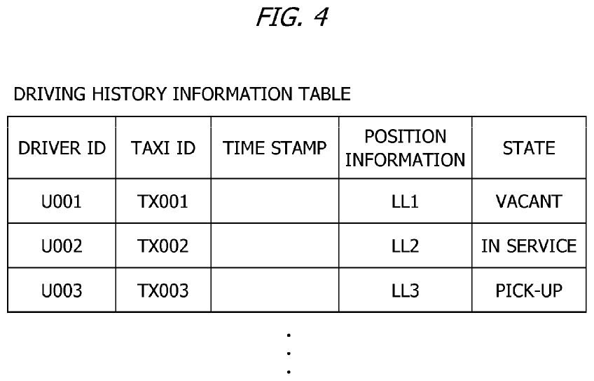

FIG. 4 is an example of a driving history information table. The driving history information table is a table held in the driving history information DB 14. In the driving history information table, driving history information pieces received from the taxis 2 are stored. The driving history information table illustrated in FIG. 4 includes driver ID, taxi ID, time stamp, position information and state fields.

In the driver ID fields, identification information pieces about the drivers are stored. In the taxi ID fields, identification information pieces about the taxis included in the driving history information pieces are stored. In the time stamp fields, time stamps included in the driving history information pieces are stored. In the position information fields, position information pieces about the taxis 2 included in the driving history information pieces are stored. In the state fields, content of indication of occupied/vacant indicators included in the driving history information pieces are stored.

The identification information pieces about the drivers are acquired, for example, by the control unit 11 acquiring identification information pieces about drivers corresponding to the identification information pieces about the taxis included in the driving history information pieces, from the driver boarding information stored in the shift information DB 16. For example, when the driving history information pieces are received from the taxis 2, the driving history information table is updated in a form of the received driving history information pieces being added. Note that the information included in the driving history information table is not limited to that illustrated in FIG. 4.

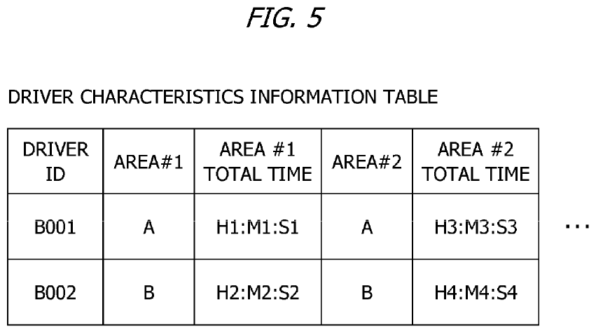

FIG. 5 is an example of a driver characteristics information table. The driver characteristics information table is stored in the driver characteristics information DB 15. In the driver characteristics information table, characteristics information pieces about the drivers obtained as a result of analyzing the driving history information pieces in the vacant state are stored. The driver characteristics information table illustrated in FIG. 5 includes driver ID, area #1, area #1 total time, area #2, area #2 total time, . . . , area #X and area #X total time fields.

In the driver ID fields, identification information pieces about the drivers are stored. In the area #1, area #2, . . . fields, for example, identification information pieces about areas are stored in descending order of the numbers of plots of positions indicated by the driving history information pieces in the vacant state. In other words, in the area #1 fields, for example, identification information pieces about areas with the largest number of plots are stored. In the area #2 fields, for example, identification information pieces about areas with the second largest number of plots are stored. However, a criterion to be the areas #1 and #2 is not limited to the number of plots of positions indicated by the driving history information but may be, for example, a density of the number of plots relative to the area of each area (the number of plots/square meters). An area where the number of plots of positions indicated by the driving history information in the vacant state is large is, in other words, an area where a time during which the taxi 2 existed in the vacant state is long during a predetermined period.

In the area #1 total time fields, the area #2 total time fields, . . . , total times of existence in the vacant state in the areas #1, the areas #2, . . . are stored, respectively. The time of existence in the vacant state in each area may be, for example, a value estimated by the number of plots X driving history information transmission interval time. Note that the method for estimating the time of existence in the vacant state in each area is not limited thereto.

The strong area is, for example, an area indicated by each of the area #1 and area #2 fields, or an area where the number of plots, the total time of existence in the vacant state or the density of the number of plots is equal to or larger than a predetermined value. In the first embodiment, the areas indicated by the area #1 and area #2 fields are assumed as strong areas.

The driver characteristics information table may be newly created, for example, each time the driving history analysis process for the taxis is performed. Note that information included in the driver characteristics information table is not limited to that illustrated in FIG. 5 but can be appropriately changed according to an embodiment.

<Flow of Process>

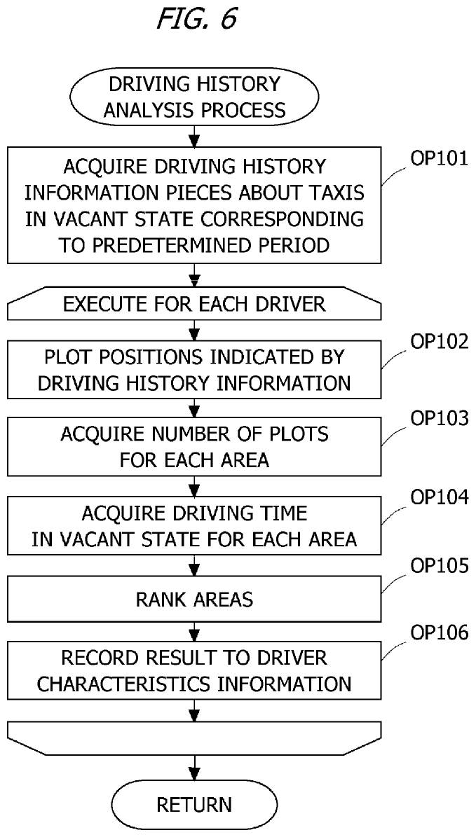

FIG. 6 is an example of a flowchart of the driving history analysis process of the center server 1. The process illustrated in FIG. 6 is started, for example, at a predetermined period or according to an instruction from the administrator. Though a subject that executes the process illustrated in FIG. 6 is the CPU 101 of the center server 1, description will be made with the control unit 11, which is a functional component, as the subject for convenience. The same goes for a flowchart after that.

At OP101, the control unit 11 acquires driving history information pieces about the taxis 2 in the vacant state during a predetermined period from the driving history information DB 14. For example, the period targeted by the driving history analysis process may be designated from the administrator or may be a fixed period set in advance. Specifically, in the case of the driving history information table illustrated in FIG. 4, the control unit 11 reads and acquires all such entries that the time stamp field indicates being during the predetermined period, and the state field indicates “vacant”, from the driving history information table.

A process from OP102 to OP106 is repeatedly executed for each of drivers corresponding to the driving history information pieces acquired at OP101. At OP102, the control unit 11 plots positions indicated by each of the driving history information pieces corresponding to the target drivers on a map. At OP103, the control unit 11 acquires the number of plots for each area. At OP104, the control unit 11 acquires, for each area, a total time of existence in the vacant state. At OP105, ranking of the areas is performed. A ranking criterion may be, for example, any of the number of plots, the total time in the vacant state and the density of the number of plots. At OP106, the control unit 11 records an analysis result to driver characteristics information. When the process from OP102 to OP106 ends for all the drivers corresponding to the driving history information pieces acquired at OP101, the process illustrated in FIG. 6 ends, and, for example, the driver characteristics information table as illustrated in FIG. 5 is created.

Note that the driving history analysis process illustrated in FIG. 6 is an example, and the driving history analysis process can be appropriately changed according to an embodiment. For example, though the driving history information pieces in the vacant state are read from the driving history information DB 14 at OP101 in the example illustrated in FIG. 6, all driving history information pieces during the predetermined period may be acquired at OP 101 instead, and the positions indicated by the driving history information pieces in the vacant state may be plotted at OP102.

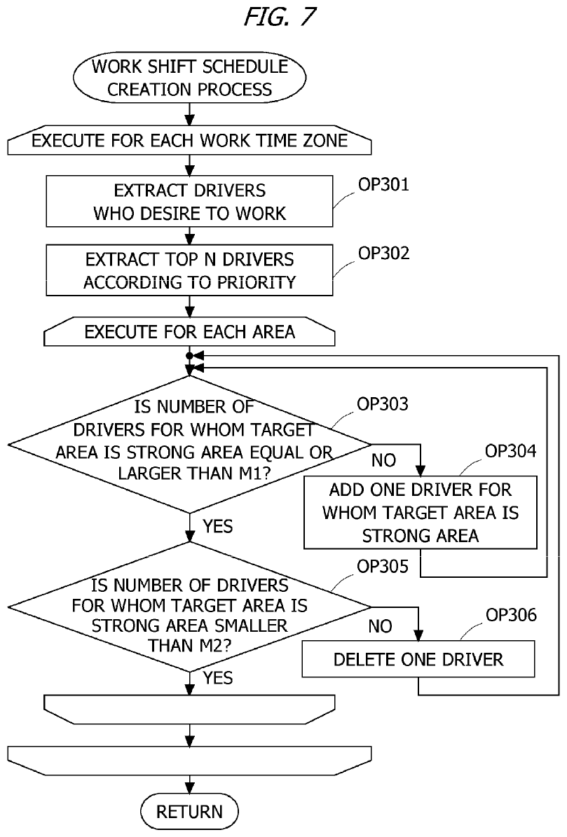

FIG. 7 is an example of a flowchart of a work shift schedule creation process of the center server 1. The process illustrated in FIG. 7 is started, for example, at a predetermined period or according to an instruction from the administrator. A process from OP301 to OP306 is executed for each work time zone. A working system differs according to operators. For example, there are a day shift from 8 o'clock to 17 o'clock, a night shift from 17 o'clock to 3 o'clock on the next day, and a day shift on every other day from 7 o'clock to 3 o'clock on the next day. In such a working system, work time zones to be targeted by the process illustrated in FIG. 7 may be, for example, two frames from 8 o'clock to 17 o'clock and from 17 o'clock to 3 o'clock on the next day.

At OP301, the control unit 11 extracts drivers who desire to work in the target work time zones. At OP302, the control unit 11 extracts top N drivers from among the drivers extracted at OP301 according to priority. The priority may be set high, for example, for a driver who is to work on the day shift on every other day in a work time zone immediately before the target work time zone. Or alternatively, the priority may be determined according to employment agreements of an employment system. For example, the priority may be set higher for a full-time employee than a part-time worker.

A process from OP303 to OP306 is executed for each area within a business range. At OP303, the control unit 11 determines whether or not the number of drivers for whom the target area is the strong area is equal to or larger than M1. M1 is a lower limit value of the number of dispatched taxis for a demand for taxis in the target area. M1 may be set for each area, may be set based on a forecast result of the demand for taxis in each area or may be set to the same fixed value in all the areas.

For example, the process of OP303 is performed by referring to the driver characteristics information table. In the case of the driver characteristics information table illustrated in FIG. 5, the control unit 11 determines whether or not the number of such drivers that the area #1 or area #2 fields indicate the target area is equal to or larger than M1. If the number of drivers for whom the target area is the strong area is equal to or larger than M1 (OP303: YES), the process proceeds to OP305. If the number of drivers for whom the target area is the strong area is smaller than M1 (OP303: NO), the process proceeds to OP304.

At OP304, the control unit 11 selects one of the drivers for whom the target area is the strong area and adds the driver to drivers to work in the target work time zone. The driver to be added is selected, for example, from among drivers to whom work in the target work time zone is not assigned and who desires to work in the target work time zone. After that, the process proceeds to OP303.

At OP305, the control unit 11 determines whether or not the number of drivers for whom the target area is the strong area is smaller than M2. M2 is an upper limit value of the number of dispatched taxis for the demand for taxis in the target area and is a value equal to or larger than M1. M2 may be set for each area, may be set based on the forecast result of the demand for taxis in each area or may be set to the same fixed value for all the areas.

For example, the process of OP305 is performed by referring to the driver characteristics information table similarly to the process of OP303. If the number of drivers for whom the target area is the strong area is equal to or smaller than M2 (OP305: YES), the process for the target area ends. After that, the process of OP303 is started for the next area. When the process ends for all the areas, the process is started from OP301 for the next work time zone. When the process ends for all the work time zones, the process illustrated in FIG. 7 ends. If the number of drivers for whom the target area is the strong area is larger than M2 (OP305: NO), the process proceeds to OP306.

At OP306, the control unit 11 deletes one of the drivers for whom the target area is the strong area, from drivers who are set to work in the target work time zone. For example, the driver to be deleted may be randomly selected from among the drivers who are set to work in the target time zone, or a driver with the lowest priority may be selected. After that, the process proceeds to OP303.

In the work shift schedule creation process illustrated in FIG. 7, a range of the number of drivers to be arranged is set for each area, and a work shift schedule is created so that the number of drivers for whom the area is the strong area is included within the range. Thereby, strong areas of drivers who work in a certain work time zone are dispersed, and, therefore, arrangement of taxis in the vacant state is naturally dispersed.

Note that the work shift schedule creation process is not limited to FIG. 7. For example, the work shift schedule creation process may be performed using work shift schedule creation software or the like.

### Operation and Effects of the First Embodiment

In the first embodiment, by analyzing the driving history information pieces about taxis in the vacant state, the strong area of each of drivers is acquired as the driver characteristics information. Since behavioral characteristics of each of the drivers in the vacant state become clear by the driver characteristics information, it is possible, for example, to dispersedly arrange taxis while respecting the drivers' wills by creating a work shift schedule so that strong areas are dispersed. By the taxis being dispersedly arranged, it is possible to, for example, even when a dispatch request from a dispatch application occurs, arrive at a user who is the request source more quickly and prevent a passenger acquisition opportunity from being lost.

### Other Embodiments

The embodiment described above is an example, and the present disclosure may be changed and carried out as appropriate without departing from the gist of the present disclosure.

In the first embodiment, analysis of the driving history information pieces about the taxis 2 during a predetermined period is performed. However, the demand for taxis fluctuates, for example, according to time zones such as the commuting time, day and midnight. For example, in the commuting time zone, the demand increases near railway stations, bus stops and the like. For example, in the midnight, the demand increases in amusement areas. Thus, even for the same driver, there is a possibility that the strong area changes for each time zone, according to change in the demand for taxis for each time zone.

Therefore, the driving history information pieces about the taxis 2 during the predetermined period may be further classified and analyzed for each time zone. By doing so, behavioral characteristics (for example, the strong area) of each driver in the vacant state for each time zone are acquired. The center server 1 may create a work shift schedule using driver characteristics information about each taxi 2 for each time zone. In this case, the work time zone and the time zone in the driving history analysis may be set to the same time zone, or one may include the other.

For example, in the case of a time width of the time zone of the driving history<a time width of the work time zone, the process from OP303 to OP306 in FIG. 7 may be executed for each time zone and each area of the driving history.

Though the strong area is considered as the driver characteristics information in the first embodiment, the driver characteristics information is not limited to the strong area but may be the total time or a driving distance in the vacant state. For example, that the total time of the vacant state in the predetermined period is longer than a predetermined time means that a time during which the taxi 2 runs with a passenger on board is short. One of reasons why the time during which the taxi 2 runs with a passenger on board is short is, for example, that the driver tends to prefer a short-distance passenger. On the contrary, for example, that the total time of the vacant state in the predetermined period is shorter than the predetermined time means that the time during which the taxi 2 runs with a passenger on board is long. One of reasons why the time during which the taxi 2 runs with a passenger on board is long is, for example, that the driver tends to prefer a passenger who moves a long distance.

In other words, from the driving history information pieces about the taxis 2 in the vacant state, tendencies of the drivers to prefer a passenger who moves a short distance or a long distance can be acquired. Therefore, at the time of creating a work shift schedule, the center server 1 may consider the tendency of each driver to prefer a passenger who moves a long distance or a short distance in addition to the strong area of the driver. Specifically, the work shift schedule may be created, for example, so that, in a certain area in a certain work time zone, a predetermined number of drivers for whom the area is the strong area and who prefer a long-distance movement or a short-distance movement are included. For example, the work shift schedule is created so that M drivers among N drivers for whom an area A is the strong area are drivers who tend to prefer a passenger who moves a long distance. For example, in the work shift schedule creation process illustrated in FIG. 7, a process for determining whether or not the number of drivers who prefer a passenger who moves a long distance or a short distance has reached a predetermined number may be performed in addition to the process from OP303 to OP306 performed for each work time zone.

For each area, the number of drivers for whom the area is the strong area and who prefer a long-distance movement or a short-distance movement may be determined by a rate to the number of drivers for whom the area is the strong area. Further, for each area, the number of drivers for whom the area is the strong area and who prefer a long-distance movement or a short-distance movement may differ according to the area or may be determined according to a demand in the area. Whether a driver prefers a passenger who moves a long distance or a short distance may be determined, for example, by whether the total time in the vacant state is shorter or longer than a predetermined threshold. The total time in the vacant state for one driver may be estimated, for example, by the number of plots of driving history information corresponding to a predetermined period X driving history information transmission intervals or by totaling values in the area #X driving time fields in the driver characteristics information table illustrated in FIG. 5.

For example, a driver who prefers a passenger who moves a long distance tends to drive in a lane in a direction away from a terminal station or the like in the vacant state. On the other hand, a driver who prefers a passenger who moves a short distance tends to drive in a lane in a direction toward a terminal station or the like in the vacant state. By taking into account of the tendency to prefer a passenger who moves a long distance or a short distance in addition to the strong area of each driver in creation of a work shift schedule, it is possible to arrange taxis while respecting drivers' wills so that both of demands for a long-distance movement and for a short-distance movement are satisfied in an area where the demands for a long-distance movement and for a short-distance movement are mixed.

The processes and means described in the present disclosure may be freely combined to the extent that no technical conflict exists.

A process which is described to be performed by one device may be performed divided among a plurality of devices. Processes described to be performed by different devices may be performed by one device. Each function is to be implemented by which hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing apparatus comprising:
a storage configured to store, in association with a taxi driver, driving history information including states of a taxi, driving positions and time stamps; and
a processor configured to analyze the driving history information about the taxi driver corresponding to a predetermined period to acquire driver characteristics information pieces indicating behavioral characteristics of the taxi driver in a vacant state of the taxi.

2. The information processing apparatus according to claim 1, wherein
the processor is configured to acquire information indicating a first area within top N areas (N is a positive integer) where a time during which the taxi existed in the vacant state during the predetermined period is long as one of the driver characteristics information pieces.

3. The information processing apparatus according to claim 2, wherein
the processor is configured to acquire the first area corresponding to the taxi driver for each of a plurality of time zones.

4. The information processing apparatus according to claim 2, wherein
the processor is configured to:
acquire the driver characteristics information pieces about a plurality of taxi drivers; and
create, based on the driver characteristics information pieces about the plurality of taxi drivers, a work shift schedule for the taxi drivers so that the first area corresponding to each of the taxi drivers is dispersed.

5. The information processing apparatus according to claim 4, wherein
the processor is configured to acquire vacant time information indicating a total time of the vacant state of the taxi during the predetermined period, as one of the driver characteristics information pieces.

6. The information processing apparatus according to claim 5, wherein
the processor is configured to create, based on the driver characteristics information pieces about the plurality of taxi drivers, the work shift schedule for the taxi drivers so that a predetermined number of such taxi drivers that the total time of the vacant state of the taxi is shorter or longer than a predetermined time are included in each of a plurality of areas in a business area that includes the plurality of areas.

7. The information processing apparatus according to claim 2, wherein
the processor is configured to acquire the first area corresponding to the taxi driver by plotting the driving positions included in the driving history information on a map.

8. The information processing apparatus according to claim 2, wherein
the processor is configured to create a work shift schedule for the taxi drivers so that, in a target area, the number of taxi drivers for whom the target area is the first area is equal to or larger than a first number and equal to or smaller than a second number.

9. A non-transitory computer-readable recording medium recorded with a program causing a computer:
store, in a storage, in association with a taxi driver, driving history information including states of a taxi, driving positions and time stamps; and
analyze the driving history information about the taxi driver corresponding to a predetermined period to acquire driver characteristics information pieces indicating behavioral characteristics of the taxi driver in a vacant state of the taxi.

10. The non-transitory computer-readable recording medium recorded with the program according to claim 9, the program causing the computer
acquire information indicating a first area within top N areas (N is a positive integer) where a time during which the taxi existed in the vacant state during the predetermined period is long as one of the driver characteristics information pieces.

11. The non-transitory computer-readable recording medium recorded with the program according to claim 10, the program causing the computer
acquire the first area corresponding to the taxi driver for each of a plurality of time zones.

12. The non-transitory computer-readable recording medium recorded with the program according to claim 10, the program causing the computer:
acquire the driver characteristics information pieces about a plurality of taxi drivers; and
create, based on the driver characteristics information pieces about the plurality of taxi drivers, a work shift schedule for the taxi drivers so that the first area corresponding to each of the taxi drivers is dispersed.

13. The non-transitory computer-readable recording medium recorded with the program according to claim 12, the program causing the computer
acquire vacant time information indicating a total time of the vacant state of the taxi during the predetermined period, as one of the driver characteristics information pieces.

14. The non-transitory computer-readable recording medium recorded with the program according to claim 13, the program causing the computer
create, based on the driver characteristics information pieces about the plurality of taxi drivers, the work shift schedule for the taxi drivers so that a predetermined number of such taxi drivers that the total time of the vacant state of the taxi is shorter or longer than a predetermined time are included in each of a plurality of areas in a business area that includes the plurality of areas.

15. The non-transitory computer-readable recording medium recorded with the program according to claim 10, the program causing the computer
acquire the first area corresponding to the taxi driver by plotting the driving positions included in the driving history information on a map.

16. The non-transitory computer-readable recording medium recorded with the program according to claim 10, the program causing the computer
create a work shift schedule for the taxi drivers so that, in a target area, the number of taxi drivers for whom the target area is the first area is equal to or larger than a first number and equal to or smaller than a second number.

17. An information processing method comprising:
store, in a storage, in association with a taxi driver, driving history information including states of a taxi, driving positions and time stamps; and
analyzing the driving history information about the taxi driver corresponding to a predetermined period to acquire driver characteristics information pieces indicating behavioral characteristics of the taxi driver in a vacant state of the taxi.

18. The information processing method according to claim 17, comprising
acquiring information indicating a first area within top N areas (N is a positive integer) where a time during which the taxi existed in the vacant state during the predetermined period is long as one of the driver characteristics information pieces.

19. The information processing method according to claim 18, comprising
acquiring the first area corresponding to the taxi driver for each of a plurality of time zones.

20. The information processing method according to claim 18, comprising
acquiring the driver characteristics information pieces about a plurality of taxi drivers; and
creating, based on the driver characteristics information pieces about the plurality of taxi drivers, a work shift schedule for the taxi drivers so that the first area corresponding to each of the taxi drivers is dispersed.
